(19) United States
(12) Patent Application Publication
(10) Pub. No.: US 2003/0101387 A1
(43) Pub. Date: May 29, 2003

(54) Apparatus and method for varying packet frame length

(75) Inventor: Seoung-Young Lee, Kunpo (KR)

Correspondence Address: FLESHNER & KIM, LLP, P.O. BOX 221200, CHANTILLY, VA, 20153, US

(73) Assignee: LG Electronics Inc.

(21) Appl. No.: 10/300,025

(22) Filed: Nov. 20, 2002

(30) Foreign Application Priority Data
Nov. 29, 2001 (KR) 87661/2001

(51) Int. Cl. G06F 11/00

(52) U.S. Cl. 714/704

(57) ABSTRACT

Embodiments of the present invention relate to receiving a first bundle of data, calculating an error rate, and adjusting a size of the second bundle. The calculating of the error rate may use the first bundle of data. Adjusting the size of the second bundle of data may use the calculated error rate. By calculating the error rate using a first bundle of data and then adjusting the size of the second bundle, embodiments of the present invention are able to increase the effectiveness of radio communication. In other words, if a radio communication has too many errors, the size of any subsequent radio signals is reduced. This reduction of size decreases the likelihood of errors in subsequent radio transmission. Likewise, if errors in a radio signal (i.e., a bundle of data) have relatively few errors, then the size of the second bundle of data can be increased to allow for more efficient transmission of data over the system.

### BACKGROUND OF THE INVENTION

1. Field of the Invention

The present invention relates to a radio packet data system, and in particular to an apparatus for controlling transmission errors.

2. Background of the Related Art

Mobile radio communication systems are used in everyday life. Garage door openers, remote controllers for home entertainment equipment, cordless telephones, hand-held walkie-talkies, pagers, and cellular telephones are all examples of mobile radio communication systems. For example, cellular radio systems provide high quality service that is often comparable to that of landline telephone systems.

However, unfortunately, errors do occur in the transmission of data in wireless communication systems. These errors may be a result of a geological environment of the wireless system, the weather, the integrity of the wire of the electronic components in the wireless system, or other circumstances. It has therefore been a long felt need for a wireless communication system to maintain quality service while maximizing efficiency of the wireless communication system.

### SUMMARY OF THE INVENTION

The object of the present invention is to at least overcome the disadvantages discussed above. Embodiments of the present invention relate to receiving a first bundle of data, calculating an error rate, and adjusting a size of the second bundle. Calculating of an error rate may use a first bundle of data. Adjusting a size of a second bundle of data may use the calculated error rate. By calculating an error rate using a first bundle of data and then adjusting the size of a second bundle, embodiments of the present invention are able to increase the effectiveness of radio communication. In other words, if radio communication (in the form of a bundle of data) has too many errors, the size of any subsequent radio signals is reduced. This reduction of size decreases the likelihood of errors in subsequent radio transmission. Likewise, if errors in a radio signal (i.e., a bundle of data) have relatively few errors, then the size of the second bundle of data can be increased to allow for more efficient transmission of data over the system. In some embodiments the error rate is a transmission error estimation.

Additional advantages, objects, and features of the invention will be set forth in part in the description which follows and in part will become apparent to those having ordinary skill in the art upon examination of the following or may be learned from practice of the invention. The objects and advantages of the invention may be realized and attained as particularly pointed out in the appended claims.

### BRIEF DESCRIPTION OF THE DRAWINGS

FIG. 1 is an exemplary block diagram illustrating an error control apparatus of a base station receiver.

FIG. 2 is an exemplary block diagram illustrating an apparatus for varying a packet frame length.

FIG. 3 is an exemplary flow chart illustrating a method for varying a packet frame length.

FIG. 4 is an exemplary probability graph for determining an adjustment range of a packet length.

### DETAILED DESCRIPTION OF PREFERRED EMBODIMENTS

In a radio communication, it is important to detect and control transmission errors caused by channel noise. Accordingly, particular coding methods are used. Particularly, error-detecting code or error-correcting code may be used. Errors may be represented as a bit error rate (BER) or a frame error rate (FER) of a system. For example, one error in 10⁸ data or 10⁻⁸ BER may indicate a good operating condition.

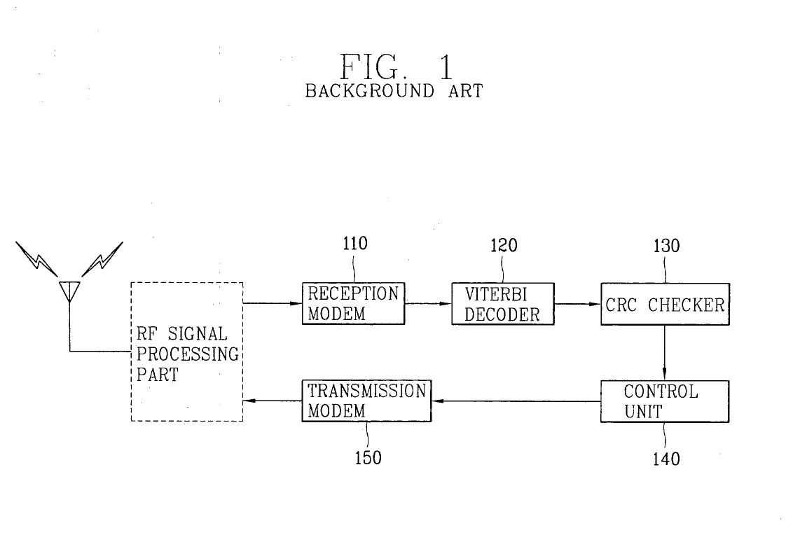

FIG. 1 illustrates an embodiment of the present invention of a packet frame length varying apparatus. The apparatus may include the following. A reception modem 110 for demodulating a packet data signal received through a radio channel. A viterbi decoder 120 for decoding a demodulated signal according to a viterbi algorithm. A CRC checker 130 for performing a CRC error check of an output signal of a viterbi decoder 120. A control unit 140 for determining whether an error packet is retransmitted by referencing integrity check information of CRC checker 130.

For example, a packet data signal may be transmitted from a terminal to a base station through a radio channel. The transmitted packet data signal may be transmitted to a reception modem 110 through a RF signal processing part. Reception modem 110 may demodulate a transmitted packet data signal and transmits it to viterbi decoder 120. Viterbi decoder 120 may decode a demodulated signal according to a viterbi algorithm and transmits it to CRC checker 130. Viterbi decoder 120 may perform error-correcting (by bit) in a decoding process. The CRC checker 130 may extract CRC from each transmitted packet frame and perform an integrity check of a pertinent frame. In an integrity check result, when there is an error in a received packet frame, control unit 140 may generate a “retransmission order signal” to retransmit a pertinent frame. A “retransmission order signal” may be transmitted to a terminal through transmission modem 150. When BER characteristics of a radio channel are uniform, a longer packet frame has a greater probability of an error occurrence than a shorter packet frame. When a state of the radio channel is unstable, a probability of an error in a packet frame increases.

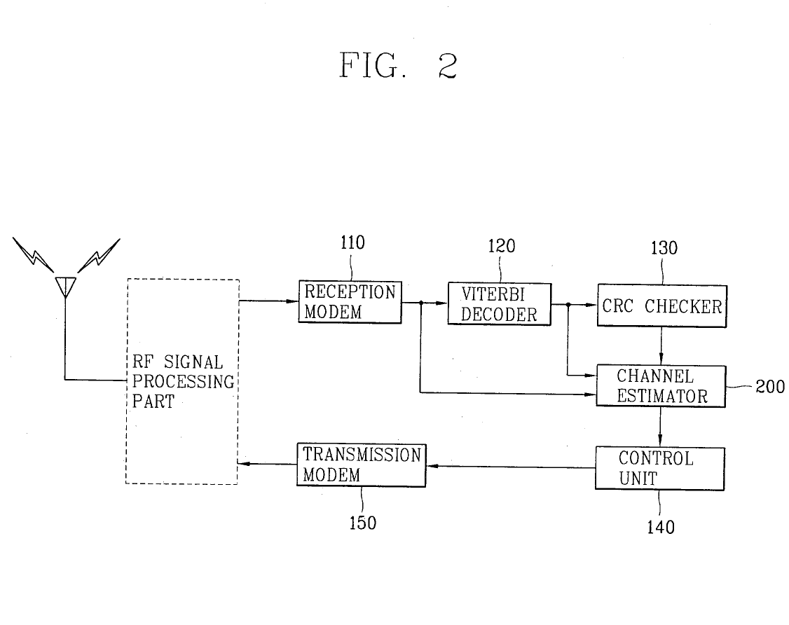

FIG. 2 is an exemplary block diagram illustrating embodiments of the present invention including an apparatus for varying a packet frame length. The apparatus may include a reception modem 110, a viterbi decoder 120, a CRC checker 130, a channel estimator 200, and a control unit 140. Reception modem 110 may be for demodulating a packet data signal received through a radio channel. Viterbi decoder 120 may be for decoding a demodulated signal according to a viterbi algorithm. CRC checker 130 may be for performing a CRC error check of an output signal of viterbi decoder 120. Channel estimator 200 may be for calculating a transmission error estimation (BER/FER) of a radio channel by referencing an error rate of a received packet signal. Control unit 140 may be for generating a “packet frame length adjustment order” according to a BER/FER and transmitting it to a terminal.

In the apparatus exemplified in FIG. 2, a state of a radio channel may be estimated by checking a BER (bit error rate) and a FER (frame error rate), after a packet signal is received. When a radio channel has many error bits or FER is high, a “packet frame length decrease order” may be transmitted to a transmission side. When a radio channel has relatively few error bits or FER is low, a “packet frame length increase order” may be transmitted to a transmission side. During transmission of a packet signal, a radio channel state estimating process and the packet frame length adjusting process may be repeatedly performed. Packet frame length of a terminal may be adjusted to be appropriate for the condition of a radio channel.

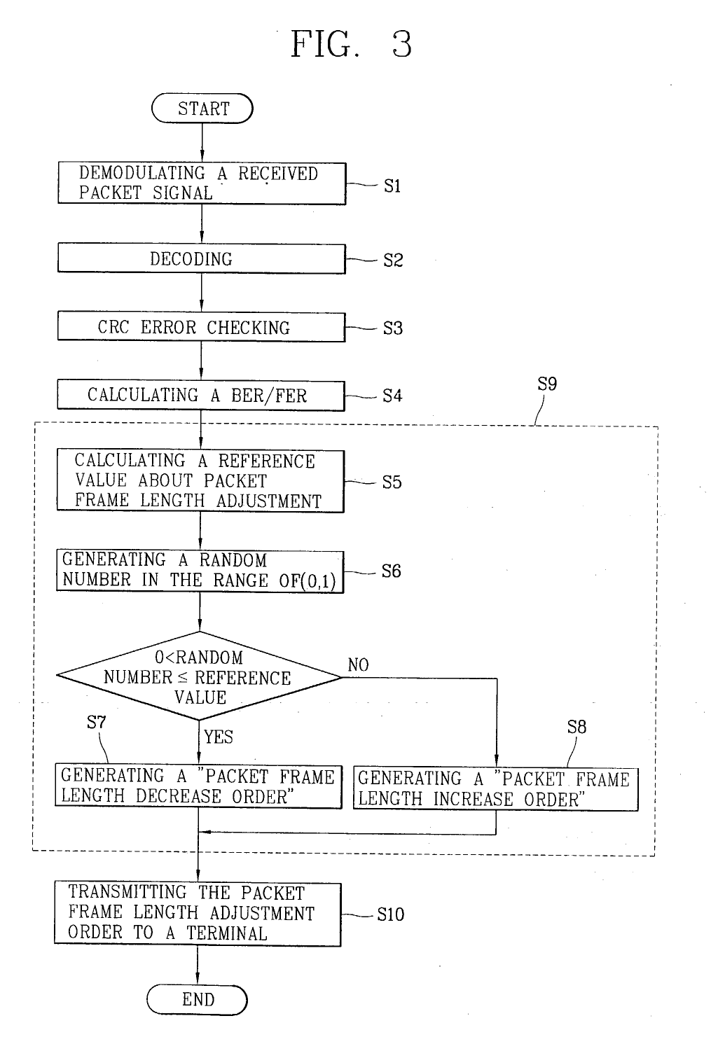

FIG. 3 is an exemplary flow chart illustrating embodiments of the present invention relating to methods for varying packet frame length. The method may include the following steps. Demodulating a packet data signal received through a radio channel, at step S1. Decoding a demodulated signal according to a viterbi algorithm, at step S2. Performing a CRC error check of a decoded signal, at step S3. Calculating a transmission error estimation (BER/FER) of a radio channel, at step S4. Generating a “packet frame length adjustment order” according to a BER/FER, at step S9. Transmitting the “packet frame length adjustment order” to a terminal, at step S10.

The “packet frame length adjustment order” generating process (step S9) may include at least one of the following steps. Calculating a reference value about a packet frame length adjustment according to a BER/FER value, as illustrated in step S5. Generating a random-number, as illustrated in step S6. Generating a packet frame length decrease order when a generated random number is greater than ‘0’ and not greater than a reference value, as illustrated in step S7. Generating a packet frame length increase order when a generated random number is greater than a reference value and smaller than ‘1’, as illustrated in step S8.

The operation of the packet frame length varying apparatus in accordance with embodiments of the present invention are illustrated in FIGS. 2 and 3. When a packet signal transmitted from a terminal is transmitted to a base station through a radio channel, the transmitted packet signal is transmitted to reception modem 110 through a RF signal processing part. Reception modem 110 demodulates a transmitted packet signal (step S1) and transmits it to viterbi decoder 120. Viterbi decoder 120 decodes a demodulated signal according to a viterbi algorithm (step S2) and transmits it to CRC checker 130. Viterbi decoder 120 performs error-correcting by bit in a decoding process. CRC checker 130 may extract a CRC code from each transmitted packet frame and perform an integrity check of a pertinent frame (step S3).

Channel estimator 200 may compare the signal inputted into viterbi decoder 120 (an output signal of a reception modem) with a signal outputted from viterbi decoder 120. Channel estimator 200 may estimate a BER of a channel. Channel estimator 200 may receive integrity check information from CRC checker 130 and may estimate a FER of a channel. Control unit 140 may calculate a BER/FER (0≦BER/FER≦14.5) by referencing BER and FER (step S4). BER/FER is a transmission error estimation of a radio channel and may be calculated by the following exemplary equation.

BER/FER=(α×BER)+(β×FER) (α, β: tuning value) [Equation 1]

Temporary deterioration of frequency circumstances and channel condition may have an adverse effect on accurate estimation of a radio channel state. Accordingly, a BER/FER value may be calculated by a moving average method. An error rate calculation by a moving average method can prevent packet frame length variation due to a transmission error caused by fast fading. When the BER/FER is calculated, the control unit 140 may generate a “packet frame length adjustment order” on the basis of a probability calculation (step S9). A generated “packet frame length adjustment order” signal may be modulated in transmission modem 150 and may be transmitted to a terminal through a radio channel (step S10).

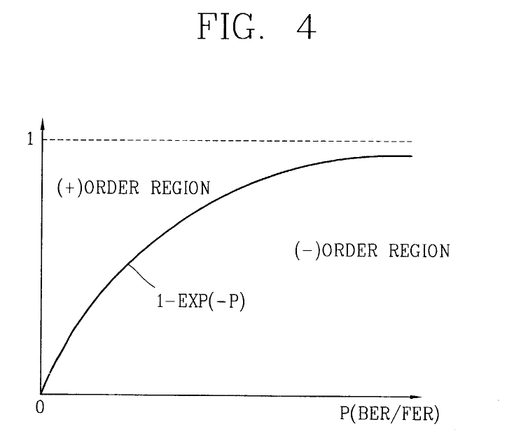

According to a received “packet frame length adjustment order” signal, length of a packet frame may be either increased or decreased. Each packet frame consists of four fields preamble, payload, CRC, postamble). A terminal may adjust the length of the packet frame by increasing or decreasing a size of the payload field. Equation 2, below, is an exemplary exponential function for determining a length adjustment region of a packet frame. FIG. 4 is an exemplary probability graph according to Equation 2.

F=1−exp(−P) (P: BER/FER value) [Equation 2]

FIG. 4 is an exemplary curved graph of the exemplary exponential function using BER/FER (0˜100%) as an input value. When an input value (BER/FER) is determined, control unit 140 calculates a result value of the exemplary exponential function. The result value may be a reference value of a packet frame length adjustment according to an input value (BER/FER) (step S5). When a reference value is calculated, a range from “0” to the reference value (0<F≦reference value) may be determined as a region for a packet frame length decrease order (hereinafter, it is referred to as ‘(−) order region’). Accordingly, a range from a reference value to ‘1’ (reference value<F<1) is determined as a region for a packet frame length increase order (hereinafter, it is referred to as ‘(+) order region’).

When an adjustment region of the packet frame length is determined, the control unit 140 may generate a random number in the range of (0, 1) (step S6). Control unit 140 may generate a packet frame length adjustment order in the generated random number region (steps S7 and S8). For example, a reference value (F) corresponding to a certain input value (BER/FER) may be 0.8, (−) order region may be 0<F≦0.8, and (+) order region may be 0.8<F<1. Size of an (−) order region may be complementary to a size of a (+) order region. When a BER/FER value increases, reference value (F) converges on ‘1’ and (−) order region is increased. In other words, the probability in which a generated random number is in a (−) order region increases gradually.

In embodiments, a “packet frame length decrease order” may not necessarily be transmitted whenever a BER/FER value is high. The packet frame length increase and decrease orders depend on probability. For example, when a BER/FER value is high, probability in which a generated random number is in the range of a (−) order region is high and probability of a packet frame length decrease order is therefore increased. When a BER/FER value is low, probability in which a generated random number is in the range of (+) order region is high and probability of a packet frame length increase order is increased.

Embodiments of the present invention relate to a packet frame length varying apparatus. The apparatus may comprise the following. A reception modem for demodulating a packet signal received through a radio channel. A decoder for decoding the demodulated signal. A CRC checker for performing a CRC error check of an output signal of the decoder. A channel estimator for calculating a transmission error estimation (BER/FER) of the radio channel by referencing an error rate of the received packet signal. A control unit for generating a “packet frame length adjustment order” according to the BER/FER and transmitting it to a terminal.

The BER/FER may be calculated by using a BER (bit error rate) and a FER (frame error rate). The channel estimator may calculate a BER by comparing an input signal with an output signal inputted/outputted from the decoder and calculates a FER by referencing integrity check information of the CRC checker. The control unit may calculate a reference value about packet frame length adjustment according to the BER/FER value and generates a random number. The control unit may generate a packet frame length decrease order, when the generated random number is greater than ‘0’ and not greater than the reference value. The control unit may generate a packet frame length increase order, when the generated random number is greater than the reference value and smaller than ‘1’.

The reference value may be calculated by follow equation:

1−exp(−P) (P: BER/FER value).

The random number may be in the range of ‘0’ and ‘1’. The decoder may be a viterbi decoder. The BER and FER may be calculated by a moving average method.

Embodiments of the present invention relate to a packet frame length varying method. The method may comprise the following steps. Demodulating a packet data signal received through a radio channel. Decoding the demodulated signal according to a viterbi algorithm. Performing a CRC error check of the decoded signal. Calculating a transmission error estimation (BER/FER) of the radio channel by referencing an error rate of the received packet signal. Generating a “packet frame length adjustment order” according to the BER/FER and transmitting it to a terminal.

The packet frame length adjustment order generating step may include the following steps. Calculating a reference value about the packet frame length adjustment according to the BER/FER value. Generating a random-number. Generating a packet frame length decrease order when the generated random-number is greater than ‘0’ and not greater than the reference value and generating a packet frame length increase order when the generated random number is greater than the reference value and smaller than ‘1’.

The reference value is calculated by follow equation:

1−exp(−P) (P: BER/FER value)

The random number may be in the range of ‘0’ and ‘1’. The BER/FER may be calculated by using a BER (bit error rate) and a FER (frame error rate). The BER may be calculated by comparing the signal before decoding with the decoded signal. The FER is calculated by referencing the CRC error check information.

In embodiments of the present invention, when a radio channel is performing ineffectively, packet frame error rate (FER) is reduced by decreasing packet frame length. Likewise, when a radio channel is performing effectively, but inefficiently, a packet frame length is increased and transmission efficiency is improved. In embodiments, if the packet frame length varying apparatus is installed in transceiver, FER of a radio channel can be reduced, the number of packet frame retransmission can be reduced, and an increase of throughput is achieved. Embodiments of the present invention prevent transmission error by adjusting a packet frame length according to an estimated radio channel state.

The foregoing embodiments and advantages are merely exemplary and are not to be construed as limiting the present invention. The present teaching can be readily applied to other types of apparatuses. The description of the present invention is intended to be illustrative, and not to limit the scope of the claims. Many alternatives, modifications, and variations will be apparent to those skilled in the art.

What is claimed is:

1. A method comprising:
receiving a first bundle of data;
calculating an error rate using at least the first bundle of data; and
adjusting a size of a second bundle of data using at least the error rate.

2. The method of claim 1, wherein the bundle of data is at least one of a packet and a frame.

3. The method of claim 1, wherein the bundle of data is in binary.

4. The method of claim 1, wherein the bundle of data is organized in a specific way for transmission.

5. The method of claim 1, wherein the error rate is a transmission error estimation.

6. The method of claim 5, wherein transmission error estimation is a ratio of:
a percentage of received bits in error compared to the total number of bits received; and
a ratio of errored data frames to a total number of frames transmitted.

7. The method of claim 6, wherein:
the percentage of received bits in error compared to the total number of bits received is a bit error rate; and
the ratio of errored data frames to a total number of frames transmitted is a frame error rate.

8. The method of claim 1, wherein the adjusting the size of the second bundle of data comprises calculating a reference value using at least the error rate.

9. The method of claim 8, wherein calculating of the reference value utilizes a predetermined relationship of reference values and error rates.

10. The method of claim 9, wherein the predetermined relationship is an exponential relationship.

11. The method of claim 8, wherein the adjusting the size of the second bundle of data comprises:
generating a random number;
comparing the reference value to the random number;
increasing the size of the second bundle if the random number is above the reference value; and
decreasing the size of the second bundle if the random number is below the reference value.

12. The method of claim 11, wherein both the reference value and the random number are greater than or equal to 0 and less than or equal to 1.

13. The method of claim 1, comprising transmitting the size of the second bundle of data.

14. The method of claim 13, comprising receiving the second bundle of data.

15. An apparatus configured to:
receive a first bundle of data;
calculate an error rate using at least the first bundle of data; and
adjust a size of a second bundle of data using at least the error rate.

16. The apparatus of claim 15, wherein the bundle of data is at least one of a packet and a frame.

17. The apparatus of claim 15, wherein the bundle of data is in binary.

18. The apparatus of claim 15, wherein the bundle of data is organized in a specific way for transmission.

19. The apparatus of claim 15, wherein the error rate is a transmission error estimation.

20. The apparatus of claim 19, wherein transmission error estimation is a ratio of:
a percentage of received bits in error compared to the total number of bits received; and
a ratio of errored data frames to a total number of frames transmitted.

21. The apparatus of claim 20, wherein:
the percentage of received bits in error compared to the total number of bits received is a bit error rate; and
the ratio of errored data frames to a total number of frames transmitted is a frame error rate.

22. The apparatus of claim 15, configured to adjust the size of the second bundle of data by calculating a reference value using at least the error rate.

23. The apparatus of claim 22, configured to calculate the reference value by utilizing a predetermined relationship of reference values and error rates.

24. The apparatus of claim 23, wherein the predetermined relationship is an exponential relationship.

25. The apparatus of claim 22, configured to adjust the size of the second bundle of data by:
generating a random number;
comparing the reference value to the random number;
increasing the size of the second bundle if the random number is above the reference value; and
decreasing the size of the second bundle if the random number is below the reference value.

26. The apparatus of claim 25, wherein both the reference value and the random number are greater than or equal to 0 and less than or equal to 1.

27. The apparatus of claim 15, configured to transmit the size of the second bundle of data.

28. The apparatus of claim 27, configured to receive the second bundle of data.
